(19) United States
(12) Patent Application Publication
(10) Pub. No.: US 2004/0150203 A1
(43) Pub. Date: Aug. 5, 2004

(54) Body accommodating airbag method and apparatus

(76) Inventor: Steven B. Cress, Glenbrook, NV (US)

Correspondence Address: Herbert C. Schulze, 2790 Wrondel Way, PMB 36, Reno, NV, 89502, US

(21) Appl. No.: 10/356,923

(22) Filed: Jan. 30, 2003

(51) Int. Cl. B60R 21/16

(52) U.S. Cl. 280/743.1

(57) ABSTRACT

This invention is an airbag system for vehicles in which a multiplicity of small individual airbags are stored at various vehicle locations such that upon the occurrence of an accident the airbags will be deployed in such manner that they surround and accommodate all parts of persons who may be in the vehicle.

### BACKGROUND OF THE INVENTION

I. Field of the Invention

This invention is in the general field of airbags utilized for the protection of humans riding in automotive vehicles and the like;

The invention is more particularly directed to segmented airbags designed to impinge lightly upon a vehicle passenger and to accommodate a body and body parts upon which it impinges

The invention is most particularly directed to multiple, segmented airbag elements wherein the segments will conform to body parts and to different size bodies and body parts for ultimate maximum protection.

II. Description of the Prior Art

There is much art in airbag deployment for the protection of humans. However, all of the attempts to my knowledge pertain only to slower deployment or multiple deployment or partitioned airbags while still deploying as large and harsh balloons.

My present invention involves any prior airbag system in so far as the actuation and deployment and materials used are concerned. However, my invention is a new, novel, unique and useful improvement which includes special shaping of fully deployed air bags which use a multiplicity of small or narrow body accommodating airbags which encompass and protect the body is if they were tailored to fit all around the body and in cooperation with a vehicle seat in a manner which approaches an actual molding about the body preventing movement in any direction as opposed to air bags of the prior art which may actually impact a body and move the body to a position of great danger and may impose injury on the body due to the forceful and unrestrained force applied.

I have been unable to find an airbag system which approaches, anticipates, or suggests my new system.

### SUMMARY OF THE INVENTION

Airbags are in wide use in vehicles or the like for the protection of persons in collisions and other vehicle mishaps. Airbags have proven to be valuable in saving lives and preventing serious injuries.

However, airbags frequently cause injuries and even death because of the rapid and very hard and unyielding force with which the airbag contact surface strikes individuals or cargo within a vehicle when the airbag is activated. This is especially true with children and infants since the large, rapidly moving huge, uncontrolled balloon-like bags have such great acceleration and momentum that serious injury, or even death, can occur when a human body is struck by them. This problem is aggravated by the fact that the airbag may strike a person at an angular relation rather than straight on. Also, the problem is aggravated in that the human body is not a simple geometric shape but is an aggregation of different tubular, spherical and angular portions of different densities presenting a complex target for an airbag.

I have now conceived and developed a system and airbag structure which consists of interacting small modular or slender air bags which will basically adhere to the body and body parts and will not strike the body in such manner as to wrench, or tear at the body or body parts such as the head, legs, arms, etc.

I have accomplished this by providing segmented individual bags of various configurations but all having the common denominator that a relatively small area of a body will be contacted by individual bags and associated individual bags will enclose the body and body parts in such manner that the body parts are not wrenched out of shape.

It is an object of this invention to provide an airbag method and apparatus which will protect passengers in vehicles but will not injure the passengers;

Another object of this invention is to provide such a method and apparatus wherein the passengers in vehicles involved in accidents will be encompassed in a number of individual, small airbags which cooperate with one another in accommodating the irregular configurations of human bodies.

The foregoing and other objects and advantages of this invention will be understood by those skilled in the art upon reading the description of a preferred embodiment, which follows, in conjunction with a review of the appended drawings.

### BRIEF DESCRIPTION OF THE DRAWINGS

FIG. 1 is a schematic view of a portion of a vehicle with a deployed air bag system suitable to practice a method of this inventions;

FIG. 2 is a schematic sectioned view on 2-2 of FIG. 1;

FIG. 3 is a schematic perspective of various shapes of airbags of this invention; and

FIG. 4 is a schematic perspective of individual bags with adhering elements.

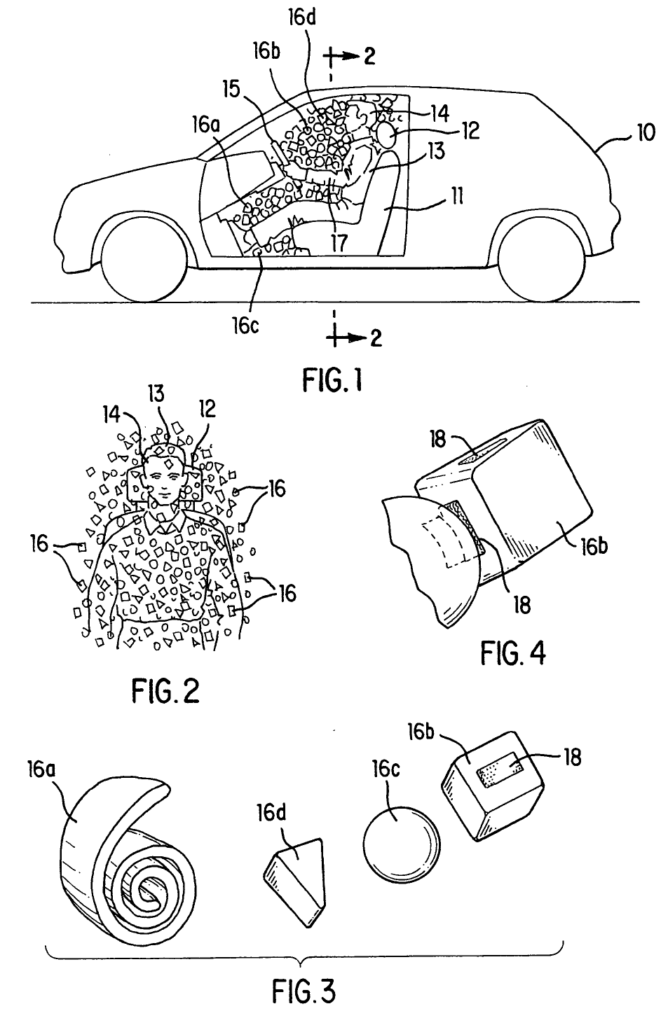

### DESCRIPTION OF A PREFERRED EMBODIMENT

An inventory of items bearing reference numerals is:

### Numeral Item Description

10 vehicle

11 seat

12 head rest

13 vehicle driver

14 driver's head

15 steering wheel

16 air bags of this invention

16a alternate form of airbag of this invention

16b alternate form of airbag of this invention

16c alternate form of airbag of this invention

16d alternate form of airbag of this invention

17 driver's arm

18 adhering elements

The figures depict an automobile or the like 10 with customary seat 11, head rest 12, and steering wheel 15. A driver 13 has one arm 17 extended out to the steering wheel.

When an accident has occurred airbags 16, and/or 16a, and/or 16b, and/or 16c, and/or 16d will be deployed about the driver and/or other persons who might be in the vehicle. The airbags will deploy in any customary manner of air bag deployment.

The airbags of this invention are all individual small bags. They may be in a multiplicity of geometric configurations such as cubes, spheres, strips, and the like. The unique, new, novel, and useful feature of this invention is the use of many individual bags in various configurations which will envelope and hold a person and each part thereof.

A driver of a vehicle, such as the driver 13 in the illustrations who has an outstretched arm may have that arm severely wrenched, broken, or even torn off by the enormous force of a single customary large airbag. Also, the arm and hand can be slapped forcibly against the driver's head possibly causing severe injury. However, with a multiplicity of small, variously shaped airbags the parts of the body can be accommodated and held in their positions by being surrounded by overlapping small shapes and/or strips. For example in the figures, the outstretched arm will still be held in that position and will, thus assist the driver in regaining control of a vehicle which may be careening after an accident.

The form of airbag shown in FIG. 3 is of particular value. The coiled strip 16a can be in the neighborhood of ten inches wide, two inches thick and six feet long. There can be many such strips overlapping and layering upon one another. Thus, a person's body and all parts will be completely accommodated and held in place as it is found. The same is true with the multiplicity of small variously shaped three dimensional airbags. Such variously shaped airbags are preferably in sizes of approximately one cubic foot each when deployed.

When airbags of this invention are used they can even be deployed more quickly than customary large airbags as they can be stored in numerous locations throughout a vehicle. They can be stored in the roof area, in the doors and seat areas as well as in the front and side areas now generally used. Also, they will completely occupy the entire interior of a vehicle and accommodate to the configuration of persons or other objects in the vehicle.

In all of these embodiments an alternate feature can be the addition of hook and loop fastening devices, magnetic strips, netting or the like which will allow adjacent airbags to attach to each other to provide a coherent mass after deployment as shown in FIG. 4. The elements 18 such as alternating hook and loop elements, magnets, or the like will hold adjacent bags in position.

By this reference I incorporate in this description of a preferred embodiment the claims and abstract which follow the same as though were set forth in detail at this point.

In the claims which follow if I omit, or fail to claim, one of the inventive features disclosed or suggested in this application, such failure will be inadvertent and is not intended to be an indication that I have abandoned or dedicated such feature. If such should happen it is my intent to reissue the patent when I discover any such omission or failure.

While the embodiments of this invention specifically shown and described are fully capable of achieving the objects and advantages desired it is to be understood that such embodiments are for purposes of illustration only and not for purposes of limitation.

I claim:

1. The method of enhancing the safety of persons within a vehicle in the event of an accident comprising: forming a multiplicity of airbags of customary airbag material, each of which is less than one cubic foot in size when deployed and the total displacement volume of all bags is equal to the total vehicle interior volume; storing quantities of such airbags at multiple locations within a vehicle;
and providing inflation means activate-able on occurrence of a vehicle accident for each of the airbags.

2. The method of claim 1 in which the airbags are formed in a multiplicity of three dimensional shapes.

3. The method of claim 1 in which at least one airbag is in the form of a coiled strip when not deployed.

4. The method of enhancing the safety of persons within a vehicle in the event of an accident comprising: forming a multiplicity of airbags of customary airbag material, each of which is in the form of an elongate hollow sleeve less than one foot in width and less than three inches in thickness and in which the total displacement volume of all bags is equal to the total vehicle interior volume; storing quantities of such airbags at multiple locations within a vehicle; and providing inflation means activate-able on occurrence of a vehicle accident for each of the airbags.
